(19) United States
(12) Patent Application Publication
(10) Pub. No.: US 2004/0095248 A1
(43) Pub. Date: May 20, 2004

(54) Drowning alarm

(76) Inventor: Yaron Nahum Mandel, Thornhill (CA)

Correspondence Address: Yaron Nahum Mandel, 14 Nottinghill Road, Thornhill, ON, L3T 4X9, CA

(21) Appl. No.: 10/295,053

(22) Filed: Nov. 15, 2002

(51) Int. Cl. G08B 23/00

(52) U.S. Cl. 340/573.6

(57) ABSTRACT

A drowning alarm is described. It is a device which activates an alarm when a person drowns, in order to alert bystanders to the drowning, so that they can save the drowning person. The device consists of two kinds of units: a portable unit, which is worn by each swimmer, and a base station, located on the pool deck or on the beach. The portable unit produces an alarm signal when the swimmer activates a manual alarm push button on the portable unit, or when a sensor on the portable unit detects that the unit is submerged in water for longer than a certain number of seconds. The alarm signal produced by the portable unit is ultrasound or audible sound, and it propagates in water to the base station. The base station activates an alarm such as a siren. The portable unit has a light emitting diode (LED), which is switched on when the portable unit activates an alarm. This identifies the portable unit which caused the alarm, so it helps deter intentional false alarms.

### BACKGROUND

1. Field of the Invention

This invention relates to drowning alarms, that is, devices producing an alarm when a person drowns, so that the person can be saved.

2. Prior Art

Each year there are many unnecessary and tragic drowning accidents, many of them involving children, that occur because no one notices the drowning. These drowning accidents occur both in swimming pools and in beaches. If the drowning is noticed in time, it is often possible to save the person.

The patent literature contains a number of patents for devices which produce an alarm in case of a drowning in order to alert a lifeguard or other swimmers or bystanders. Prior art U.S. patents include U.S. Pat. No. 5,619,187 (Serfontein, 1997), U.S. Pat. No. 5,463,598 (Holland, 1995), U.S. Pat. No. 5,408,222 (Yaffe, 1995), U.S. Pat. No. 4,813,025 (Rowland, 1989), U.S. Pat. No. 4,714,914 (Boe, 1987), U.S. Pat. No. 4,630,205 (Otaka, 1986), U.S. Pat. No. 4,549,169 (Moura, 1985), U.S. Pat. No. 4,305,143 (Simms, 1981), U.S. Pat. No. 3,810,146 (Lieb, 1974).

These devices have not been used on a large scale. Reasons for this could be complexity, high cost, low reliability, and susceptibility to intentional false alarms.

### SUMMARY

The object of the invention is a drowning alarm, which is a device that alarms upon a drowning of a person, alerting other people to the incident, so that they can save the person's life. This invention addresses the shortcomings of the prior art patents. It is simple, reliable, inexpensive, and it deters intentional false alarms. It can be used in a swimming pool or a beach.

The device comprises two kinds of units. A portable unit is worn by each swimmer. It transmits alarm signals to the base station in case of a drowning. The base station is located on the pool deck or on the beach. It receives an alarm signal from a portable unit, and it activates a siren, a bell, a buzzer or another alarm.

In the preferred embodiment, the portable units transmit alarm signals to the base station using audible sound. Ultrasound alarm signals can also be used for this purpose. The portable unit is battery powered and is worn by each swimmer using an elastic band on a body part which is above water level some of the time

A drowning is detected and alarmed either when the portable unit senses that it is submerged in water longer than a certain number of seconds, or when the swimmer activates a manual alarm push button on the portable unit. A light emitting diode (LED) on the portable unit lights up upon an alarm. This deters intentional false alarms.

### DRAWING FIGURES

FIG. 1: A portable unit worn by a swimmer, and the base station, shown on a pool deck.

FIG. 2: A schematic of a portable unit.

FIG. 3: A schematic of the base station.

FIG. 4: A schematic of a portable unit with a second transmitter.

FIG. 5: A schematic of the base station with a second receiver.

### REFERENCE NUMERALS IN DRAWING FIGURES

1. A portable unit worn by a swimmer.

2. The base station.

3. Elastic band.

4. Battery.

5. Manual alarm push button.

6. Sensor to detect submerging in water.

7. Transmitter for audible sound or ultrasound alarm signals.

8. Light emitting diode (LED) to indicate that the unit produced an alarm.

9. Electronics.

10. Receiver for audible sound or ultrasound alarm signals.

11. Loud alarm such as siren or buzzer or bell.

12. Electronics.

13. A second receiver for audible sound or ultrasound or radio alarm signals.

14. A second transmitter for audible sound or ultrasound or radio alarm signals.

### DETAILED DESCRIPTION

The invention is a drowning alarm, which is a device that alarms upon a drowning of a person, so that other people are alerted to the incident, and they can save the person's life. The device can be used in swimming pools and on beaches.

The following is a detailed description of the preferred embodiment of the device.

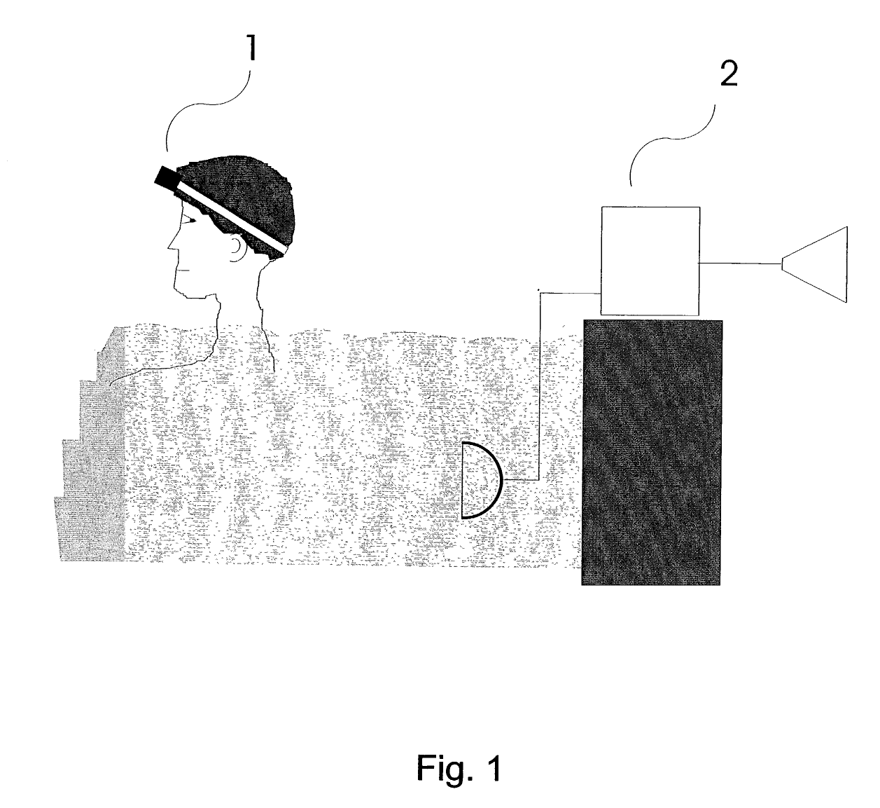

Refer to FIG. 1. The device comprises two kinds of units: a portable unit that is worn by each swimmer (1 in FIG. 1), and a base station located on the pool deck or beach (2 in FIG. 1).

The portable unit is battery powered and is worn by each swimmer using an elastic band on a body part which is above water some of the time. Such a body part can be the head, the neck, shoulder, arm, elbow, wrist, upper chest or upper back.

It is best to wear the portable unit on the head, because the swimmer's head has to get out of the water every few seconds in order to breathe. This decreases the likelihood of false alarms. If the swimmer wears the portable unit elsewhere, for example on the shoulder or neck, it is possible for the portable unit to be submerged in water even when the swimmer's head is above water. This will trigger a false alarm.

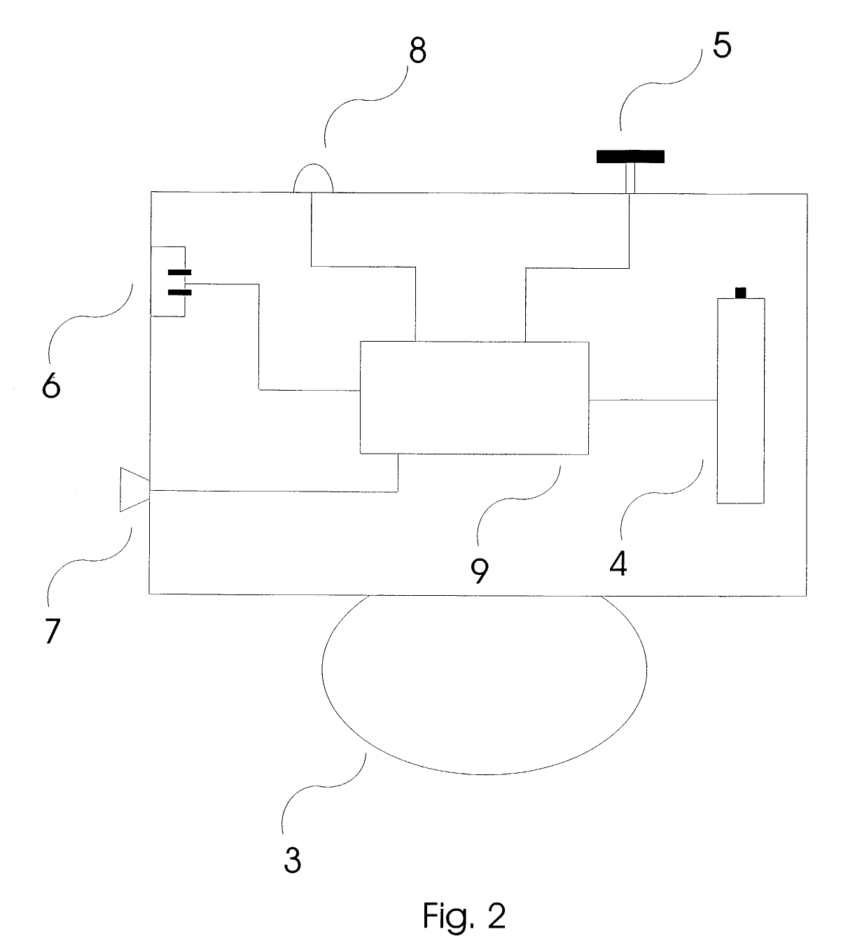

Refer to FIG. 2. The portable unit comprises the following parts: elastic band (3 in FIG. 2), battery (4 in FIG. 2), manual alarm push button (5 in FIG. 2), sensor to detect if the unit is submerged in water (6 in FIG. 2), transmitter to send audible sound or ultrasound alarm signals to the base station (7 in FIG. 2), a light emitting diode (LED) to indicate that the unit produced an alarm signal (8 in FIG. 2), and electronics to control all the parts (9 in FIG. 2).

The portable unit has a sensor which can detect whether it is submerged in water (6 in FIG. 2). This sensor can use any property which is different in air compared to water, such as conductivity or capacitance. If conductivity is used, the sensor comprises a pair of open contacts. The water conducts electrical current between the contacts, but the air does not. When capacitance is used, the sensor is based on the different electrical capacitance properties of water and air.

The sensor will produce an alarm only when it is submerged in water longer than a certain number of seconds. This time delay is necessary to ensure that an alarm will be produced only when the person is actually drowning. For example, if a person just dives for a few seconds, the portable unit will not produce an alarm. However, when the person activates the manual alarm push button on the portable unit (5 in FIG. 2), no time delay is used, and the unit produces an alarm signal immediately. In both cases the alarm signal is automatically reset after a few minutes.

The light emitting diode (LED) on the portable unit (8 in FIG. 2) is activated for a few minutes when the unit produces an alarm signal. This is intended to deter intentional false alarms. A person who wishes to cause such a prank would be discouraged if he knows that he will be identified. It is possible to have the LED indicate how the alarm originated. For example, if the alarm is produced by the manual alarm push button, then the LED will flash. If the alarm is produced by the sensor which detects that the unit is submerged in water, then the LED will be lit, but will not flash. The LED switches off automatically after a few minutes.

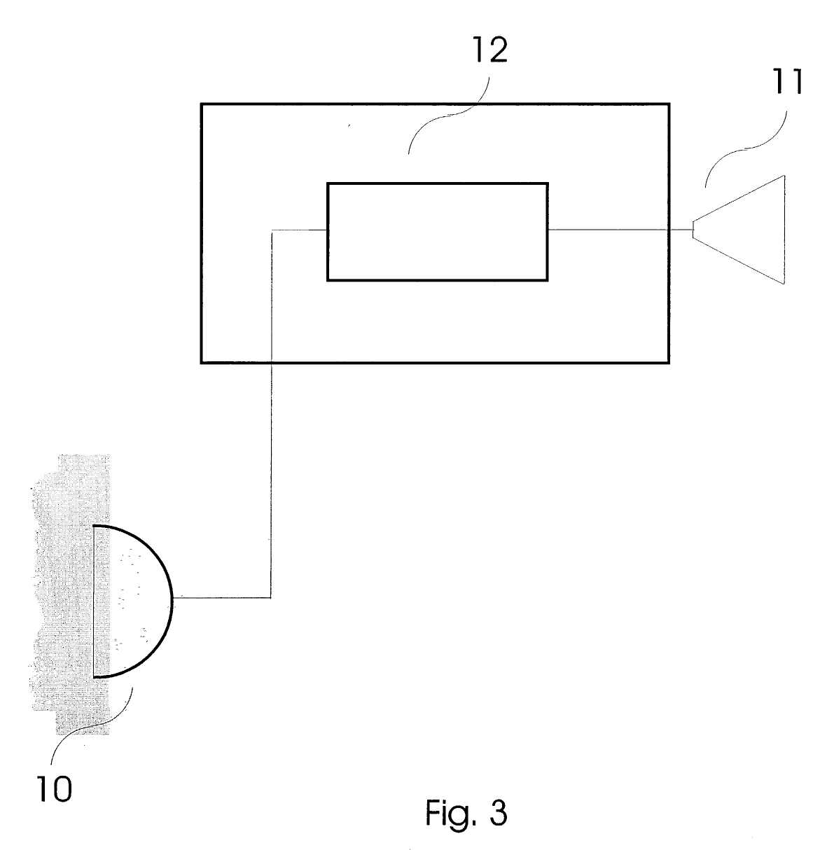

Refer to FIG. 3. The base station comprises the following parts: a receiver that is submerged in water to receive the audible sound or ultrasound alarm signals from the portable units (10 in FIG. 3), a loud alarm such as siren or buzzer or bell (11 in FIG. 3), and electronics to control all the parts (12 in FIG. 3). The base station activates the loud alarm (siren or buzzer or bell) when it receives an alarm signal from a portable unit. The base station can be reset from an alarm state either automatically after a few minutes, or manually with a reset switch. If a reset switch is used, it should only be accessible to a lifeguard or a supervisor.

In case of a drowning, the portable unit produces an alarm signal either by the swimmer activating the manual alarm push button, or by the sensor detecting that the unit is submerged in water for longer than a certain number of seconds. The alarm signal is ultrasound or audible sound. It propagates in water and it is detected by the receiver in the base station. The base station then activates a loud alarm such as siren or bell or buzzer.

In the preferred embodiment, the portable unit produces alarm signals in audible sound. The advantage is that when the portable unit is above water level, the audible alarm signal that it produces can be heard by a lifeguard, a swimmer or a bystander. So the portable unit produces an audible alarm that is independent of the base station. If the base station has already activated its own loud alarm, the audible signal coming from the portable unit makes no difference and will probably not even be heard. However if the base station has not yet detected the alarm signal coming from the portable unit, the audible alarm signal from the portable unit may help alert people to the drowning earlier. This is a useful feature, because a drowning is often preceded by a struggle by the swimmer to stay afloat.

This device is not intended to replace a human lifeguard or another supervisor. It is intended to improve the task of supervising swimmers and bathers and make it safer. The device may malfunction, for example when the battery is flat. Therefore swimmers should not be left in a pool or on the beach on their own without supervision even with this device in operation.

The device can also be used as a man overboard alarm for a ship. For this use, the ship will have to be equipped with a receiver which is submerged in water, and which is connected to a base station on the ship. Each person that has to be protected in case he falls overboard, such as a crew member or a passenger, has to wear a portable unit while he is on the deck.

While the above description contains many specifics, these should not be construed as limitations on the scope of the invention, but rather as an exemplification of one preferred embodiment thereof. Many variations are possible, for example:

The manual alarm push button on the portable unit can be eliminated.

The sensor that detects that the portable unit is submerged in water can be eliminated. In this case the unit will produce an alarm signal when the manual alarm push button is activated.

Stationary manual alarm push buttons can be added at the base station or around the pool or beach.

The light emitting diode (LED) on the portable unit can be eliminated.

A dialer or cellular phone can be added on the base station to summon help from the office or from another location.

A low battery indicator can be added to the portable unit.

The device can use an ultrasound alarm signal from the portable unit to the base station, instead of using an audible sound alarm signal.

In addition to a receiver that is submerged in the water, the base station can have a second receiver located outside the water. This receiver will detect alarm signals produced by the portable unit above water level. These signals propagate in air.

If the base station has two receivers as described in the previous paragraph, it is possible to have the two receivers detecting two different signals. For example, the receiver that is submerged in water can detect ultrasound alarm signals, and the receiver that is in the air can detect audible sound alarm signals. In this case the portable unit will have two transmitters, one for audible sound and one for ultrasound, and both transmitters will be activated in case of a drowning.

In the setup described in the previous paragraph, it is also possible to use radio signals. These signals propagate well in air. So the receiver that is in the air will be a radio receiver, and the portable unit will have a radio transmitter.

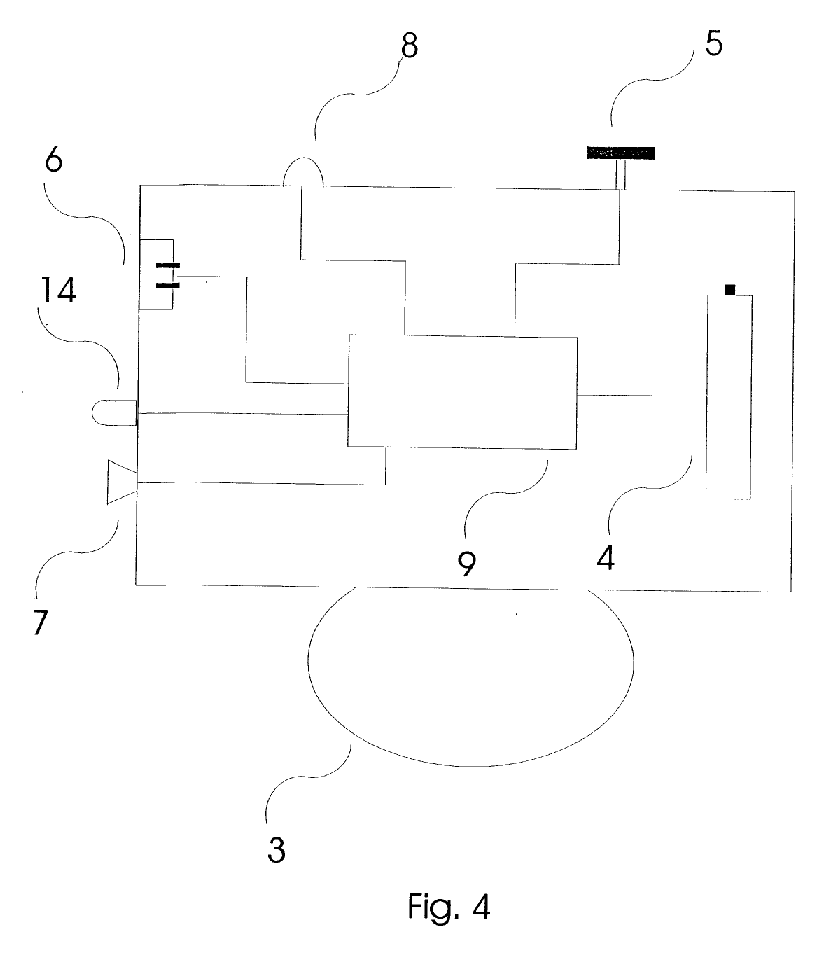

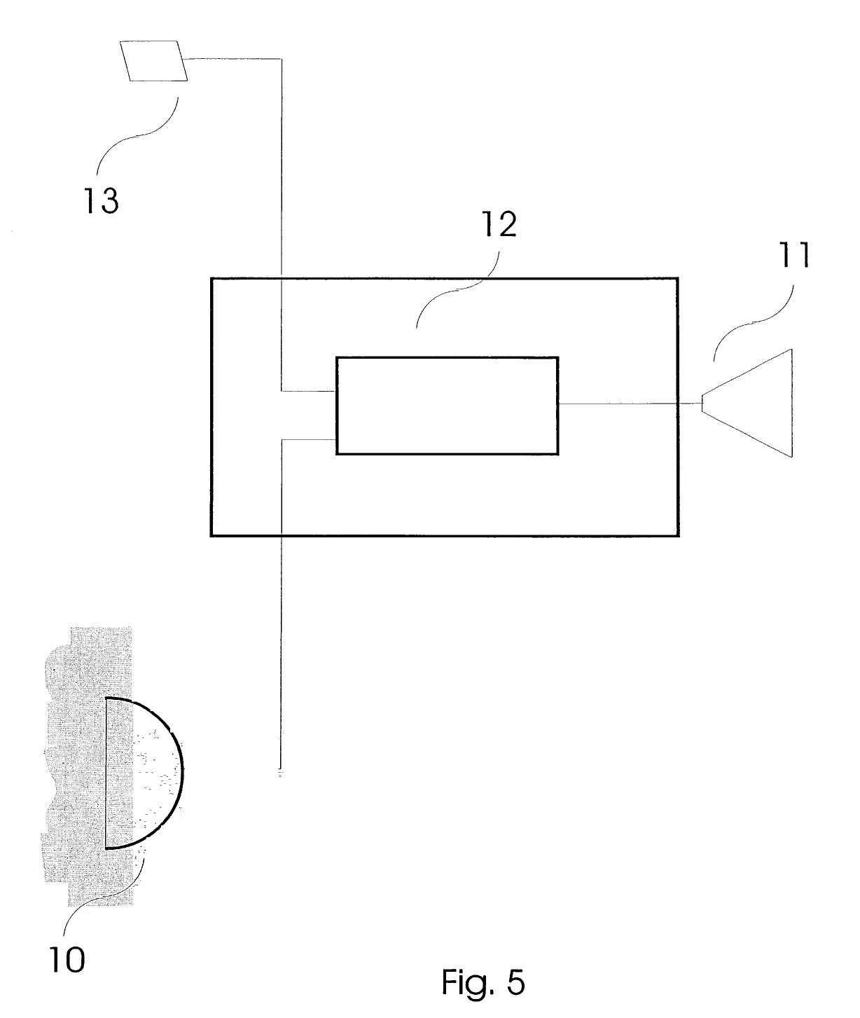

Refer to FIG. 4, where the portable unit has a second transmitter (14). Refer to FIG. 5, where the base station has a second receiver (13) that is located in the air.

The foregoing description of the preferred embodiment of the invention and some possible variations has been presented for the purposes of illustration and description. It is not intended to be exhaustive or to limit the invention to the precise form disclosed. Many modifications and variations are possible. It is intended that the scope of the invention be limited not by this detailed description, but rather by the claims appended hereto.

I claim:

1. A drowning alarm device comprising
a plurality of portable units, each worn by a swimmer, each comprising
a sensor that detects if said portable unit is submerged in water,
and a transmitter that activates a sound energy alarm signal when said sensor detects that said portable unit is submerged in water for a certain number of seconds;
and a base station comprising
a receiver which is submerged in water, and which detects said sound energy alarm signals originating from said portable units,
and a device producing a loud alarm when said receiver detects said sound energy alarm signals.

2. The drowning alarm device in claim 1 wherein said sound energy alarm signal is audible sound.

3. The drowning alarm device in claim 1 wherein said sound energy alarm signal is ultrasound.

4. The drowning alarm device in claim 1 wherein said portable unit further comprising a manual push button to activate said sound energy alarm signal from said transmitter.

5. The drowning alarm device in claim 1 wherein said portable unit further comprising a light source which is lit when said transmitter activates said sound energy alarm signal, whereby the portable unit causing the alarm is identified.

6. The drowning alarm device in claim 1 wherein said base station further comprising a second receiver which is located in the air, and which detects said sound energy alarm signals when said portable unit activates said signals above water level.

7. The drowning alarm device in claim 1 wherein said base station further comprising a second receiver which is located in the air, and said portable unit further comprising a second transmitter, whereby said second transmitter activates sound energy alarm signals, and said second receiver detects said sound energy alarm signals when said portable unit activates said signals above water level.

8. The drowning alarm device in claim 1 wherein said base station further comprising a second receiver which is located in the air, and said portable unit further comprising a second transmitter, whereby said second transmitter activates radio alarm signals, and said second receiver detects said radio alarm signals when said portable unit activates said signals above water level.

9. A drowning alarm device comprising
a plurality of portable units, each worn by a swimmer, each comprising
a manual push button,
and a transmitter that activates a sound energy alarm signal when said swimmer activates said manual push button;
and a base station comprising
a receiver which is submerged in water, and which detects said sound energy alarm signals originating from said portable units,
and a device producing a loud alarm when said receiver detects said sound energy alarm signals.

10. The drowning alarm device in claim 9 wherein said sound energy alarm signal is audible sound.

11. The drowning alarm device in claim 9 wherein said sound energy alarm signal is ultrasound.

12. The drowning alarm device in claim 9 wherein said portable unit further comprising a sensor that detects if said portable unit is submerged in water, and that activates said sound energy alarm signal from said transmitter when said sensor detects that said portable unit is submerged in water for a certain number of seconds.

13. The drowning alarm device in claim 9 wherein said portable unit further comprising a light source which is lit when said transmitter activates said sound energy alarm signal, whereby the portable unit causing the alarm is identified.

14. The drowning alarm device in claim 9 wherein said base station further comprising a second receiver which is located in the air, and which detects said sound energy alarm signals when said portable unit activates said signals above water level.

15. The drowning alarm device in claim 9 wherein said base station further comprising a second receiver which is located in the air, and said portable unit further comprising a second transmitter, whereby said second transmitter activates sound energy alarm signals, and said second receiver detects said sound energy alarm signals when said portable unit activates said signals above water level.

16. The drowning alarm device in claim 9 wherein said base station further comprising a second receiver which is located in the air, and said portable unit further comprising a second transmitter, whereby said second transmitter activates radio alarm signals, and said second receiver detects said radio alarm signals when said portable unit activates said signals above water level.
